(19) United States
(12) Patent Application Publication
(10) Pub. No.: US 2024/0147000 A1
(43) Pub. Date: May 2, 2024

(54) CLIENT TRANSCODING OF VIDEO SEGMENT

(71) Applicant: Microsoft Technology Licensing, LLC, Redmond, WA (US)

(72) Inventors: Nicholas Tegan HECKMAN, Kirkland, WA (US); Nitin SURI, Redmond, WA (US); Ohad ATIA, Redmond, WA (US); Steven Craig PETERSON, Bloomington, MN (US)

(21) Appl. No.: 17/978,556

(22) Filed: Nov. 1, 2022

(51) Int. Cl. H04N 21/4402; H04N 21/44; H04N 21/442

(52) U.S. Cl. CPC H04N 21/440245; H04N 21/44008; H04N 21/44209

(57) ABSTRACT

Client-side transcoding of a video segment of a video into a particular version. The video streaming service determines that the video segment of the video is to be transcoded into the particular version. Rather than transcode the video segment itself, the service identifies to a client that is streaming the video that the video segment of the video is to be transcoded into the particular version. The client responds by transcoding the video segment into the particular version, and transmitting the transcoded video segment back to the video streaming service.

### BACKGROUND

A video hosting service allows many users in differing locations to stream videos that have been uploaded to the video hosting service. A variety of contexts exist in which a user may initiate streaming of videos. For example, a link to the video may be selected by the user to initiate streaming of that video. As an example, that link might be, for instance, in a chat window, an e-mail, a file sharing system, a document, a video conferencing log, and so forth. To prepare for streaming, uploaded video may be transcoded into different versions to accommodate the capabilities and internet speeds of user devices that request the video. Accordingly, the proper transcoded version can be provided to the device considering the capabilities of the device. Thus, the video is more smoothly streamed on the device.

In one conventional method for video transcoding, a video provider uploads a video to the video hosting service. The video hosting service then transcodes the video into many different versions. A streaming device that has selected to view the video receives a manifest of the available video versions from the video hosting device. The streaming device selects one of the video versions considering its own capabilities (including internet speed). The video hosting service then provides that selected video version to the streaming device. The streaming device may select to view the video in particular version, possibly depending on changes in the capabilities of the streaming device, such that the streaming device could continue providing a smooth playback experience.

However, in this particular conventional method, because the video hosting service transcodes many videos into many different versions upon upload, the video hosting service requires a large amount of computational power and storage. Additionally, for some less-viewed videos, many different versions would never be streamed, and thus transcoding the video into many different versions upon upload would be a waste of computational power.

The subject matter claimed herein is not limited to embodiments that solve any disadvantages or that operate only in environments such as those described above. Rather, this background is only provided to illustrate one exemplary technology area where some embodiments describe herein may be practiced.

### BRIEF SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Embodiments described herein relate to a video streaming service causing client-side transcoding of a video segment of a video into a particular version. The video streaming service determines that the video segment of the video is to be transcoded into the particular version. For instance, that particular version may correspond to a particular bitrate and/or format (such as a frame rate and/or codec). For example, the client may make its own determination as to whether or not to provide the transcoding based on whether or not the client can do so without adversely impacting its own performance. Alternatively, or in addition, the service may ask the client to perform the transcoding based on the service's evaluation of the client's capability to perform the transcoding.

Rather than transcode the video segment itself, the video streaming service identifies to a client that is streaming the video that the video segment of the video is to be transcoded into the particular version. The client responds by transcoding the video segment into the particular version, and transmitting the transcoded video segment back to the video streaming service.

Since the transcoding is not performed by the video streaming service, processing resources of the video streaming service may be preserved. Furthermore, if the capacity of the client is taken into consideration to avoid impacting performance of the client or the network of the client, this offloading of the transcoding may be done without adversely impacting the client. Also, since the client is already streaming the video, separate authentication and authorization is not required in order to have the client aid in transcoding the video. Additionally, since the client is already streaming the video, the client may already have the video segment in a form (e.g., a higher bitrate version of a particular format) that may be transcoded into the particular version (e.g., a lower bitrate version of the same format) that the video streaming service is seeking, thus preserving network bandwidth involved with sending the video segment to the client that is to perform the transcoding.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and details through the use of the accompanying drawings in which:

FIG. 1 illustrates an environment in which the principles described herein may be practiced, and includes several clients that are streaming a video from a server;

FIG. 2 illustrates a flowchart of a method for transcoding of a video into a particular version, in accordance with the principles described herein;

FIG. 3 illustrates an example of a computational report that includes processor usage data, memory usage data, storage usage data, network bandwidth usage data, client capabilities and potentially other data as represented by the ellipsis;

FIG. 4 illustrates an example communication that is sent from the server to the client that is to perform transcoding, which communication includes the video segment to be transcoded, and an instruction to perform the transcoding, in accordance with the principles described herein; and

FIG. 5 illustrates an example computing system in which the principles described herein may be employed.

### DETAILED DESCRIPTION

Embodiments described herein relate to a video streaming service causing client-side transcoding of a video segment of a video into a particular version. The video streaming service determines that the video segment of the video is to be transcoded into the particular version. For instance, that particular version may correspond to a particular bitrate and/or format (such as a frame rate and/or codec).

Rather than transcode the video segment itself, the video streaming service identifies to a client that is streaming the video that the video segment of the video is to be transcoded into the particular version. The client responds by transcoding the video segment into the particular version, and transmitting the transcoded video segment back to the video streaming service. For instance, the client may make its own determination as to whether or not to provide the transcoding based on whether or not the client can do so without adversely impacting its own performance. Alternatively, or in addition, the service may ask the client to perform the transcoding based on the service's evaluation of the client's capability to perform the transcoding.

Since the transcoding is not performed by the video streaming service, processing resources of the video streaming service may be preserved. Furthermore, if the capacity of the client is taken into consideration to avoid impacting performance of the client or the network of the client, this offloading of the transcoding may be done without adversely impacting the client. Also, since the client is already streaming the video, separate authentication and authorization is not required in order to have the client aid in transcoding the video. Additionally, since the client is already streaming the video, the client may already have the video segment in a form (e.g., a higher bitrate version of a particular format) that may be transcoded into the particular version (e.g., a lower bitrate version of the same format) that the video streaming service is seeking, thus preserving network bandwidth involved with sending the video segment to the client that is to perform the transcoding. This further improves that speed at which the transcoded video segment may be performed.

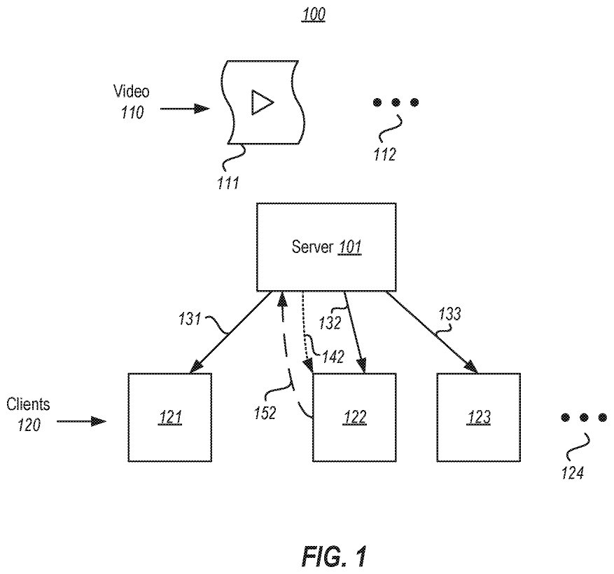

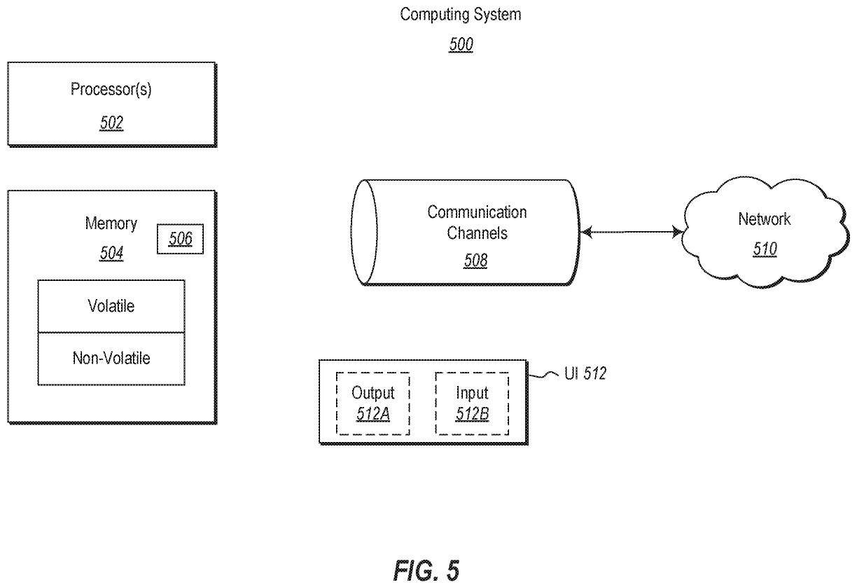

FIG. 1 illustrates an environment 100 in which the principles described herein may be practiced, and includes a server from which multiple clients are streaming a video. Specifically, the environment 100 includes a server 101 and clients 120. As an example only, the server 101 and each of the clients 120 may be computing systems and may be structured as described below for the computing system 500 of FIG. 5.

Each of the clients 120 are streaming a video from the server 101. Accordingly, for this reason, the server 101 will be termed a “server” because in this context the server 101 is providing a streaming service, and each of the clients 120 will be termed a “client” because they are receiving streaming of a video. That does not preclude the server 101 from being a client in other contexts, nor does it preclude any of the clients 120 being a server in another context. The server 101 may also be a service, such as a video streaming service.

A video is typically divided into multiple video segments for the streaming process, each video segment corresponding to a period of time of the video. To stream a video, a client will play from a video segment corresponding to a current time, and will make sure that the appropriate video segments are lined up so that when the time for playing any given video segment arrives, that video segment is ready at the client. Of course, if there is no video segment available as the time for that video segment arrives, the streaming process pauses.

However, the client monitors its performance and the performance of the network so as to potentially change the video segments to a different version if appropriate. For instance, if there is sufficient capacity (e.g., network bandwidth) at the client, the client may upgrade to a higher bitrate version of the same format, or downgrade the video segments to a lower bitrate version of the same format if there is not sufficient capacity at the client. Thus, the streaming can change over time by having the client request the proper version of upcoming video segments given the client's capabilities. When a client is “streaming a video”, this means that the client is downloading appropriate video segments of that video, and playing those video segments at the appropriate time.

The clients 120 are illustrated as including three clients 121, 122 and 123. However, the ellipsis 124 represents that there may be any number of clients that may be streaming any of the videos 110 that are hosted by the server 101. There may be anywhere from only one client 121, to potentially many or perhaps innumerable numbers of clients that are being streamed videos from the server 101. The client 121 will also be referred to herein as a “first client”, the client 122 will also be referred to herein as a “second client”, and the client 123 will also be referred to herein as a “third client”. However, the use of the term “first”, “second”, “third” and so forth is merely used to distinguish one similar thing from another, and does not imply any type of ordering.

The solid-lined arrows 131, 132 and 133 each represent that the corresponding clients are streaming a particular video 111. For instance, arrow 131 represents streaming of the video 111 from the server 101 to the first client 121, arrow 132 represents streaming of the video 111 from the server 101 to the second client 122, and arrow 133 represents streaming of the video 111 from the server 101 to the third client 123. However, the ellipsis 124 again represents that there may be only two clients 121 and 122 that are being streamed the video 111, or potentially more than two clients being streamed the video 111, and that there may be other clients that are streaming other videos (as represented by the ellipsis 112) of the videos 110.

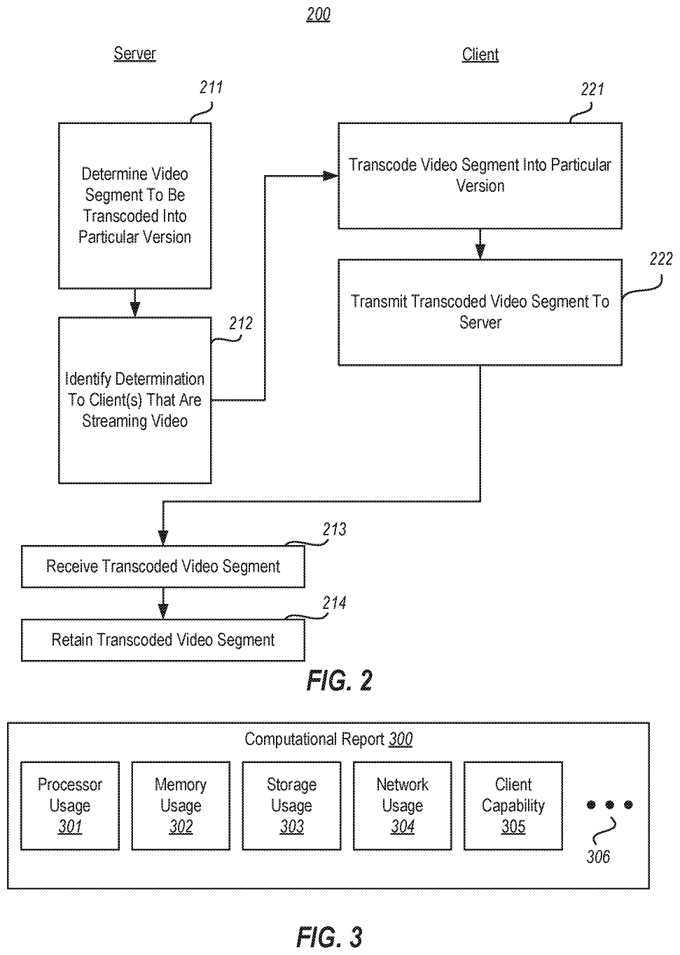

FIG. 2 illustrates a flowchart of a method 200 for transcoding of a video segment video into a particular version, in accordance with the principles described herein. Some acts of the method 200 may be performed by the server 101 of FIG. 1 as identified in the left column of FIG. 2 under the heading “Server”. Other acts of the method 200 may be performed by one of the clients 120 of FIG. 1, and are identified in the right column of FIG. 2 under the heading “Client”. In the example that follows, it is the second client 122 that performs the transcoding. Accordingly, the method 200 will now be described with reference to both the method 200 of FIG. 2 and the environment 100 of FIG. 1.

The method 200 is initiated upon a server determining that a video segment of a video is to be transcoded into a particular version (act 211). For example, the server 101 may determine that a video segment of the video 111 is to be transcoded into a particular version.

This determination may be performed for example by determining that another client (e.g., the first client 121) is currently streaming the video and is to stream the video segment in the particular version. As an example, the first client 121 may specifically request the particular version of the video segment of the video 111, but the server 101 does not have that particular version of the video segment of that video 111. This embodiment has an advantage in that transcoding is deferred until it is known that the particular version of the video segment is actually going to be streamed. Thus processing of a particular version of the video segment that will not be streamed is avoided, thereby saving computing resources.

In another embodiment, the server performs the determination that a video segment is to be transcoded into a particular version (act 211) by predicting that there is a possibility that the particular version of the video segment is to be streamed, and determining that the predicted possibility is sufficient to justify transcoding of the video segment of the video into the particular version. This prediction may be rules based and/or based on a machine-learned model. For instance, the server may determine that any video segment that has over a certain percentage chance of being streamed in the next predetermined time period should indeed be transcoded.

In response to this determination (act 211), the server identifies to a client that is streaming the video that the video segment is to be transcoded into the particular version (act 212). For instance, the server 101 may identify to any one or more of the clients 120 that the video segment of the video 111 is to be transcoded into the particular version. In the example, the second client 122 performs the transcoding. Accordingly, the server 101 identifies (as represented by dotted-lined arrow 142) to the second client 122 that the video segment of the video 111 is to be transcoded.

However, the server 101 may have identified that the video segment of the video is to be transcoded to multiple or even perhaps all of the clients 120, and it just happens that the second client 122 was the client that accepted the duty of transcoding. In one embodiment, the identification to the client may be deferred until the server first determines that the client has downloaded as part of the streaming process a version of the same video segment but in a version that is transcodable to the particular version of that same video segment. For instance, the server may first determine that the second client 122 has downloaded the same video segment but corresponding to a higher bitrate than the particular bitrate that the video segment is to be transcoded into. Alternatively, or in addition, the client may first determine that it has possession of the video segment to be transcoded before performing the transcoding.

In the example, the client responds to detecting receipt from the server of this identification by transcoding another version of the video segment of the video into the particular version of the video segment of the video (act 221). In the example, the second client 122 transcodes another version of the video segment into the particular version of the video segment. For instance, if the second client 122 had previously streamed the same video segment of video 111 at a higher bitrate than the bitrate corresponding to the particular version of that same video segment, then the second client 122 may already have the higher bitrate version of the video segment. Thus, the second client 122 may then transcode that higher bitrate version of the video segment without the server 101 having to provide the higher bitrate version of the video segment. This reduces the lag required to perform the transcoding, and saves network bandwidth since retransmission of the video segment to the client that is to perform the transcoding may be avoided.

After one of the clients transcodes the video segment of the video (act 221), the client that performed the transcoding then transmits the transcoded version of the video segment back to the server (act 222). The server then receives the transcoded video segment (act 213). For instance, in the example, the second client 122 transmits (as represented by dashed-lined arrow 152) the particular version of the video segment back to the server 101. The received video segment is thereafter retained (act 214) for future use (e.g., to provide to a streaming client that requests the video segment).

That particular version of the video segment is then available should it later be requested by one of the streaming clients. As an example, if the determination that the video segment is to be transcoded into the particular version (act 211) was performed in response to the first client 121 actually requesting that particular version of the video segment, that video segment may then be streamed to the first client 121 as represented by the arrow 131. However, even in the case where the determination that the transcoding was to be performed (act 211) occurred without a pending request for that particular version, there is still a good chance that the particular version of the video segment will be requested. Accordingly, the streaming experience is improved (or server processing resources are preserved) should such a request be received by the server 101.

In one embodiment, the server 101 itself determines which client is going to be doing the transcoding based on which of one or more of the clients also have the capacity to transcode the video segment of the video into the version to be streamed to the first client. For instance, referring to FIG. 2, in an embodiment referred to herein as a “multiple-capable” embodiment, both the second client 122 and the third client 123 are capable of transcoding the video segment, and the video segment is one that is to be streamed to the first client 121.

An embodiment in which multiple of the other clients (e.g., clients 122 and 123) are determined to be capable of transcoding the video segment will be referred to as a “multiple-capable client”. In an embodiment referred to herein as a “single-capable” embodiment, only the second client 122 (and not the third client 123) is capable of transcoding the video segment, and the video segment is to be streamed to the first client 121.

The determination of whether a client has the capacity to transcode the video segment may be based on a computational report received from the other client. This permits for more accurate determination of the capacity to transcode the video since the client has possession of its own performance and capability parameters and may thus accurately report its relevant performance and capability parameters.

The determination that a client (e.g., the second client or the third client) has a capacity to transcode the video segment of the video may be performed by applying rules to at least some information provided in the computational report, or perhaps by applying information provided in the computational report as input to a machine-learned model that is trained to predict transcoding capability. The use of a rules-based model allows for determinations that are less computationally intensive. The use of a machine-learned model allows for determinations that may be more accurate and involve complex balancing of computing parameters.

The computational report may comprise any information about the client that is relevant to determine whether the client has the capability to perform the transcoding. FIG. 3 illustrates an example of a computational report 300 that includes various computing capacity parameters including for example processor usage data 301, memory usage data 302, storage usage data 303, network bandwidth usage data 304, client capabilities 305, and potentially other data as represented by the ellipsis 306. Since each of this data are relevant to a client's spare capacity, any one or combination of this usage data allows for more accurate determinations as to capacity. Thus, clients are less likely to be asked to transcode when they do not have capacity to transcode.

Each client that is streaming video may periodically send computational reports to the server. The sending of periodic computational reports allows the data to be refreshed, thereby allowing for more accurate determinations as to the client's capability to transcode that is appropriate given the current conditions experienced by the client.

If it is determined that no other client has the capacity to transcode the version of the video segment of the video, the server 101 itself will perform the transcoding. However, if there is a determination that at least one other client is capable of performing the transcoding, then the video segment and a transcode instruction is sent to one of the clients instructing the client to perform that transcoding.

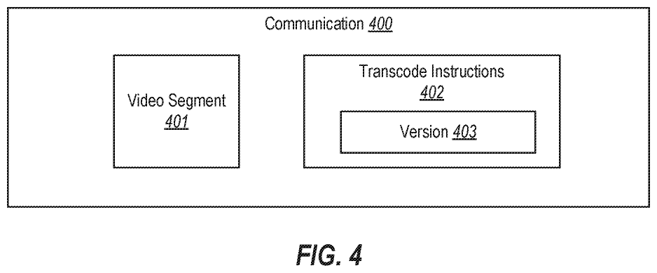

FIG. 4 illustrates an example communication 400 that is sent from the server to the client that is to perform the transcoding. The communication 400 includes the video segment 401 to be transcoded, and an instruction 402 to perform the transcoding. However, as previously mentioned, the sending of the video segment 401 may be avoided if the client already has possession of the video segment 401. The instruction 402 references a version 403 that the video segment is to be transcoded into. As an example, the version may be specified by bitrate and/or format.

Referring to FIG. 1, in the single-capable embodiment, the server 101 sends the transcode instruction to the second client 122 to perform the transcoding. In the multiple-capable embodiment, the server 101 may send the transcode instruction to either of the clients 122 or 123 to perform the transcoding. In that case, the server 101 may distribute the transcoding amongst the multiple other clients that are capable of performing the transcoding.

Alternatively, in the multiple-capable embodiment, the server 101 may select one of the clients from amongst multiple of the clients that are each capable of performing the transcoding. This selection may be performed by applying rules to information provided by at least some of the multiple-capable clients, or perhaps by applying information provided by at least some of the multiple-capable clients as input to a machine-learned model trained to predict a best client to perform the transcoding.

As an example, in the case where both clients 122 and 123 provided the computational report, the information that is applied to a rules-based model or the machine-learned model may include information from both of the computational resource reports. The use of a rules-based model allows for selections that are less computationally intensive. The use of a machine-learned model allows for selections that may be more accurate and involve complex balancing of computing parameters.

Accordingly, the principles described herein allow for transcoding of a video segment to be offloaded from a server (such as a video streaming service) to a client that has the capability to perform the transcoding. Since the client has the capability to perform the transcoding, the performance of the client is not reduced. Furthermore, since the transcoding was performed by a client that already is streaming the video, separate authentication and authorization of the helping client need not be performed.

Because the principles described herein are performed in the context of a computing system, some introductory discussion of a computing system will be described with respect to FIG. 5. Computing systems are now increasingly taking a wide variety of forms. Computing systems may, for example, be handheld devices, appliances, laptop computers, desktop computers, mainframes, distributed computing systems, data centers, or even devices that have not conventionally been considered a computing system, such as wearables (e.g., glasses). In this description and in the claims, the term “computing system” is defined broadly as including any device or system (or a combination thereof) that includes at least one physical and tangible processor, and a physical and tangible memory capable of having thereon computer-executable instructions that may be executed by a processor. The memory may take any form and may depend on the nature and form of the computing system. A computing system may be distributed over a network environment and may include multiple constituent computing systems.

As illustrated in FIG. 5, in its most basic configuration, a computing system 500 includes at least one hardware processing unit 502 and memory 504. The processing unit 502 includes a general-purpose processor. Although not required, the processing unit 502 may also include a field programmable gate array (FPGA), an application specific integrated circuit (ASIC), or any other specialized circuit. In one embodiment, the memory 504 includes a physical system memory. That physical system memory may be volatile, non-volatile, or some combination of the two. In a second embodiment, the memory is non-volatile mass storage such as physical storage media. If the computing system is distributed, the processing, memory and/or storage capability may be distributed as well.

The computing system 500 also has thereon multiple structures often referred to as an “executable component”. For instance, the memory 504 of the computing system 500 is illustrated as including executable component 506. The term “executable component” is the name for a structure that is well understood to one of ordinary skill in the art in the field of computing as being a structure that can be software, hardware, or a combination thereof. For instance, when implemented in software, one of ordinary skill in the art would understand that the structure of an executable component may include software objects, routines, methods (and so forth) that may be executed on the computing system. Such an executable component exists in the heap of a computing system, in computer-readable storage media, or a combination.

One of ordinary skill in the art will recognize that the structure of the executable component exists on a computer-readable medium such that, when interpreted by one or more processors of a computing system (e.g., by a processor thread), the computing system is caused to perform a function. Such structure may be computer readable directly by the processors (as is the case if the executable component were binary). Alternatively, the structure may be structured to be interpretable and/or compiled (whether in a single stage or in multiple stages) so as to generate such binary that is directly interpretable by the processors. Such an understanding of example structures of an executable component is well within the understanding of one of ordinary skill in the art of computing when using the term “executable component”.

The term “executable component” is also well understood by one of ordinary skill as including structures, such as hard coded or hard wired logic gates, that are implemented exclusively or near-exclusively in hardware, such as within a field programmable gate array (FPGA), an application specific integrated circuit (ASIC), or any other specialized circuit. Accordingly, the term “executable component” is a term for a structure that is well understood by those of ordinary skill in the art of computing, whether implemented in software, hardware, or a combination. In this description, the terms “component”, “agent”, “manager”, “service”, “engine”, “module”, “virtual machine” or the like may also be used. As used in this description and in the case, these terms (whether expressed with or without a modifying clause) are also intended to be synonymous with the term “executable component”, and thus also have a structure that is well understood by those of ordinary skill in the art of computing.

In the description that follows, embodiments are described with reference to acts that are performed by one or more computing systems. If such acts are implemented in software, one or more processors (of the associated computing system that performs the act) direct the operation of the computing system in response to having executed computer-executable instructions that constitute an executable component. For example, such computer-executable instructions may be embodied on one or more computer-readable media that form a computer program product. An example of such an operation involves the manipulation of data. If such acts are implemented exclusively or near-exclusively in hardware, such as within a FPGA or an ASIC, the computer-executable instructions may be hard-coded or hard-wired logic gates. The computer-executable instructions (and the manipulated data) may be stored in the memory 504 of the computing system 500. Computing system 500 may also contain communication channels 508 that allow the computing system 500 to communicate with other computing systems over, for example, network 510.

While not all computing systems require a user interface, in some embodiments, the computing system 500 includes a user interface system 512 for use in interfacing with a user. The user interface system 512 may include output mechanisms 512A as well as input mechanisms 512B. The principles described herein are not limited to the precise output mechanisms 512A or input mechanisms 512B as such will depend on the nature of the device. However, output mechanisms 512A might include, for instance, speakers, displays, tactile output, virtual or augmented reality, holograms and so forth. Examples of input mechanisms 512B might include, for instance, microphones, touchscreens, virtual or augmented reality, holograms, cameras, keyboards, mouse or other pointer input, sensors of any type, and so forth.

Embodiments described herein may comprise or utilize a special-purpose or general-purpose computing system including computer hardware, such as, for example, one or more processors and system memory, as discussed in greater detail below. Embodiments described herein also include physical and other computer-readable media for carrying or storing computer-executable instructions and/or data structures. Such computer-readable media can be any available media that can be accessed by a general-purpose or special-purpose computing system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: storage media and transmission media.

Computer-readable storage media includes RAM, ROM, EEPROM, CD-ROM, or other optical disk storage, magnetic disk storage, or other magnetic storage devices, or any other physical and tangible storage medium which can be used to store desired program code means in the form of computer-executable instructions or data structures and which can be accessed by a general-purpose or special-purpose computing system.

A “network” is defined as one or more data links that enable the transport of electronic data between computing systems and/or modules and/or other electronic devices. When information is transferred or provided over a network or another communications connection (either hardwired, wireless, or a combination of hardwired or wireless) to a computing system, the computing system properly views the connection as a transmission medium. Transmission media can include a network and/or data links which can be used to carry desired program code means in the form of computer-executable instructions or data structures and which can be accessed by a general-purpose or special-purpose computing system. Combinations of the above should also be included within the scope of computer-readable media.

Further, upon reaching various computing system components, program code means in the form of computer-executable instructions or data structures can be transferred automatically from transmission media to storage media (or vice versa). For example, computer-executable instructions or data structures received over a network or data link can be buffered in RAM within a network interface module (e.g., a “NIC”), and then be eventually transferred to computing system RAM and/or to less volatile storage media at a computing system. Thus, it should be understood that storage media can be included in computing system components that also (or even primarily) utilize transmission media.

Computer-executable instructions comprise, for example, instructions and data which, when executed at a processor, cause a general-purpose computing system, special-purpose computing system, or special-purpose processing device to perform a certain function or group of functions. Alternatively, or in addition, the computer-executable instructions may configure the computing system to perform a certain function or group of functions. The computer executable instructions may be, for example, binaries or even instructions that undergo some translation (such as compilation) before direct execution by the processors, such as intermediate format instructions such as assembly language, or even source code.

Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computing system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, datacenters, wearables (such as glasses) and the like. The invention may also be practiced in distributed system environments where local and remote computing system, which are linked (either by hardwired data links, wireless data links, or by a combination of hardwired and wireless data links) through a network, both perform tasks. In a distributed system environment, program modules may be located in both local and remote memory storage devices.

Those skilled in the art will also appreciate that the invention may be practiced in a cloud computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

For the processes and methods disclosed herein, the operations performed in the processes and methods may be implemented in differing order. Furthermore, the outlined operations are only provided as examples, and some of the operations may be optional, combined into fewer steps and operations, supplemented with further operations, or expanded into additional operations without detracting from the essence of the disclosed embodiments.

The present invention may be embodied in other specific forms without departing from its spirit or characteristics. The described embodiments are to be considered in all respects only as illustrative and not restrictive. The scope of the invention is, therefore, indicate by the appended claims rather than by the foregoing description. All changes which come within the meaning and range of equivalency of the claims are to be embraced within their scope.

1-20. (canceled)

21. A computing system comprising:
one or more processors; and
one or more computer-readable media having thereon computer-executable instructions that are executable by the one or more processors to cause the computing system to:
stream a video to a plurality of client devices, the video stream being in a first version;
during streaming of the video, determine that a first client device of the plurality of client devices is to receive a video segment of the video transcoded into a second version, the second version having a different bitrate, format, or both a different bitrate and format from the first version;
responsive to determining that the first client device is to receive the video segment transcoded to the second version, send a request to a second client device of the plurality of client devices to transcode the video segment to the second version;
receive the video segment of the video transcoded into the second version from the second client device, the video segment having been transcoded by the second client device responsive to the request; and
cause the video segment transcoded to the second version to be streamed to the first client device, the video segment streamed by the computing system to the first client device without the computing system transcoding the video segment into the second version.

22. The computing system of claim 21, wherein the instructions are further executable to cause the computing system to:
select the second client device from the plurality of client devices based on a previously received computational report sent by the second client device, the computational report indicating that the second client device has capacity to transcode the video segment to the second version.

23. The computing system of claim 22, wherein the computational report comprises one or more of: processor usage data, memory usage data, storage usage data, or network bandwidth usage data.

24. The computing system of claim 21, wherein determining that the first client device is to receive the video segment of the video transcoded into the second version comprises predicting, prior to a request for the video segment in the second version, that the first client device will request the video segment in the second version.

25. The computing system of claim 21, wherein determining that the first client device is to receive the video segment of the video transcoded into the second version comprises receiving a request for the video segment in the second version from the first client device.

26. The computing system of claim 21, wherein the instructions are further executable to cause the computing system to select the second client device based on identifying that the second client device was streamed a version of the video segment that has a higher bitrate than a bitrate of the second version.

27. The computing system of claim 21, wherein sending the request to the second client device comprises including a version of the video segment having a higher bitrate than a bitrate of the second version.

28. A method for streaming video, the method being performed by a computing system and comprising:
streaming a video to a plurality of client devices, the video stream being in a first version;
during streaming of the video, determining that a first client device of the plurality of client devices is to receive a video segment of the video transcoded into a second version, the second version having a different bitrate, format, or both a different bitrate and format from the first version;
responsive to determining that the first client device is to receive the video segment transcoded to the second version, sending a request to a second client device of the plurality of client devices to transcode the video segment to the second version;
receiving the video segment of the video transcoded into the second version from the second client device, the video segment having been transcoded by the second client device responsive to the request; and
causing the video segment transcoded to the second version to be streamed to the first client device, the video segment streamed by the computing system to the first client device without the computing system transcoding the video segment into the second version.

29. The method of claim 28, the method further comprising:
selecting the second client device based on a previously received computational report sent by the second client device, the computational report indicating that the second client device has capacity to transcode the video segment to the second version.

30. The method of claim 29, wherein the computational report comprises one or more of: processor usage data, memory usage data, storage usage data, or network bandwidth usage data.

31. The method of claim 28, wherein determining that the first client device is to receive the video segment of the video transcoded into the second version comprises predicting, prior to a request for the video segment in the second version, that the first client device will request the video segment in the second version.

32. The method of claim 28, wherein determining that the first client device is to receive the video segment of the video transcoded into the second version comprises receiving a request for the video segment in the second version from the first client device.

33. The method of claim 28, wherein the second client device is selected based on identifying that the second client device was streamed a version of the video segment that has a higher bitrate than a bitrate of the second version.

34. The method of claim 28, wherein sending the request to the second client device to transcode the video segment to the second version comprises including a version of the video segment having a higher bitrate than a bitrate of the second version.

35. A computer-readable medium having thereon instructions that are executable by one or more processors of a computing system to cause the computing system to:
stream a video to a plurality of client devices, the video stream being in a first version;
during streaming of the video, determine that a first client device of the plurality of client devices is to receive a video segment of the video transcoded into a second version, the second version having a different bitrate, format, or both a different bitrate and format from the first version;
responsive to determining that the first client device is to receive the video segment transcoded to the second version, send a request to a second client device of the plurality of client devices to transcode the video segment to the second version;
receive the video segment of the video transcoded into the second version from the second client device, the video segment having been transcoded by the second client device responsive to the request; and
cause the video segment transcoded to the second version to be streamed to the first client device, the video segment streamed by the computing system to the first client device without the computing system transcoding the video segment into the second version.

36. The computer-readable medium of claim 35, wherein the second client device is selected based on a previously received computational report sent by the second client device, the computational report indicating that the second client device has capacity to transcode the video segment to the second version.

37. The computer-readable medium of claim 36, wherein the computational report comprises one or more of: processor usage data, memory usage data, storage usage data, or network bandwidth usage data.

38. The computer-readable medium of claim 35, wherein determining that the first client device is to receive the video segment of the video transcoded into the second version comprises predicting, prior to a request for the video segment in the second version, that the first client device will request the video segment in the second version.

39. The computer-readable medium of claim 35, wherein the second client is tasked with determining its availability as to whether the second client is able to transcode the video segment to the second version.

40. The computer-readable medium of claim 35, wherein:
the second client was previously granted streaming authentication to stream the video,
a determination is made that said transcoding is to be offloaded to the second client,
the second client, which is currently streaming the video, is instructed to transcode the video segment, and
as a result of the second client already having streaming authentication to currently stream the video, a determination is made that a separate transcoding authentication is not required to have the second client also aid in transcoding the video segment.
